(19) United States
(12) Patent Application Publication
(10) Pub. No.: US 2017/0148148 A1
(43) Pub. Date: May 25, 2017

(54) IMAGE PROCESSING DEVICE, IMAGE DISPLAY SYSTEM AND VEHICLE PROVIDED WITH SAME, IMAGE PROCESSING METHOD AND RECORDING MEDIUM RECORDS PROGRAM FOR EXECUTING SAME

(71) Applicant: Panasonic Intellectual Property Management Co., Ltd., Osaka (JP)

(72) Inventors: TETSURO OKUYAMA, Osaka (JP); YOSHIHITO OHTA, Osaka (JP); MASATAKA EJIMA, Osaka (JP)

(21) Appl. No.: 15/426,131

(22) Filed: Feb. 7, 2017

Related U.S. Application Data
(63) Continuation of application No. PCT/JP2015/005100, filed on Oct. 8, 2015.

(30) Foreign Application Priority Data
Oct. 30, 2014 (JP) 2014-221927

(51) Int. Cl. G06T 5/50; G06T 7/20; B60R 1/00; G06T 7/00

(52) U.S. Cl. CPC G06T 5/50; G06T 7/97; G06T 7/20; B60R 1/00; G06T 2207/10016; G06T 2207/30252

(57) ABSTRACT

The image processing device includes: a first motion vector detecting section detects a first motion vector indicating a motion from a subsequent frame to the target frame; a second motion vector detecting section detects a second motion vector indicating a motion from a previous frame to the target frame; a first moved image generating section generates data of a first moved image based on data of the subsequent frame and the first motion vector; a second moved image generating section generates data of a second moved image based on data of the previous frame and the second motion vector; and a corrected image generating section generates data of a corrected image, based on data of the target frame, and the data of the first and the second moved images.

### BACKGROUND

1. Technical Field

The present disclosure relates to an image processing technique for processing moving image data captured and generated by an imaging apparatus.

2. Description of the Related Art

An apparatus that is mounted on a vehicle, captures a front or rear traffic situation of the vehicle, and displays the situation on a display screen has been developed. For example, Patent Literature 1 discloses an image processing device that is mounted on a vehicle and can erase an object disturbing visibility such as snow or rain from a captured image. The image processing device of Patent Literature 1 determines whether to perform correction on image data from an imaging means, detects, in the image data, pixels of an obstacle that is a predetermined object floating or dropping in the air, replaces the pixels of the detected obstacle by other pixels, and outputs data of an image after the pixel substitution.

### CITATION LIST

### Patent Literature

PTL 1: WO: 2006/109398

### SUMMARY

Light emitting diode (LED) devices have been widespread as light-emitting devices for headlights of vehicles or traffic lights in recent years. In general, an LED device is driven in a predetermined driving period. On the other hand, a camera that is mounted on a vehicle and captures an image typically has an imaging period of about 60 Hz.

In a case where a driving period of an LED device is different from an imaging period of a camera (imaging device), the difference between these periods causes unintentional capturing of a state of repetitive lighting and extinguishing, that is, flicker, of the LED device.

The present disclosure provides an image processing device that can reduce flicker or the like in captured moving image data.

In a first aspect of the present disclosure, an image processing device is provided. The image processing device includes a first motion vector detecting section, a second motion vector detecting section, a first moved image generating section, a second moved image generating section, and a corrected image generating section. The first motion vector detecting section detects a first motion vector indicating a motion from a subsequent frame subsequent to a target frame to the target frame. The second motion vector detecting section detects a second motion vector indicating a motion from a previous frame preceding the target frame to the target frame. The first moved image generating section generates data of a first moved image based on data of the subsequent frame and the first motion vector. The second moved image generating section generates data of a second moved image based on data of the previous frame and the second motion vector. The corrected image generating section generates data of a corrected image in which the target frame is corrected, based on data of the target frame, the data of the first moved image, and the data of the second moved image.

In a second aspect of the present disclosure, an image display system is provided. The image display system includes: an imaging device that captures an image in units of frames and generates image data; the image processing device that receives the image data from the imaging device; and a display device that displays an image shown by the data of the corrected image generated by the image processing device.

In a third aspect of the present disclosure, an image processing method is provided. The image processing method includes the steps of: detecting a first motion vector; detecting a second motion vector; generating data of a first moved image; generating data of a second moved image; and generating data of a corrected image. The first motion vector indicates a motion from a subsequent frame subsequent to a target frame to the target frame. The second motion vector indicates a motion from a previous frame preceding the target frame to the target frame. The data of the first moved image is generated based on data of the subsequent frame and the first motion vector. The data of the second moved image is generated based on data of the previous frame and the second motion vector. The data of the corrected image is generated and outputted by correcting the target frame based on data of the target frame, the data of the first moved image, and the data of the second moved image.

An image processing device according to the present disclosure can further reduce flicker or the like in captured moving image data. For example, even in a case where a driving period of a light-emitting device (LED device) that is an object is different from an imaging period of an imaging device, moving image data with reduced flicker of the light-emitting device can be generated.

### BRIEF DESCRIPTION OF DRAWINGS

FIG. 1 illustrates a configuration of an image display system.

FIG. 2A illustrates a configuration of an image processing device of the image display system.

FIG. 2B illustrates another configuration (with the presence of a reliability signal) of the image processing device of the image display system.

FIG. 3 is an illustration for describing a motion vector that is detected by a motion vector detecting section of the image processing device.

FIG. 4 is an illustration for describing a concept of an image correction process that is performed by the image processing device.

FIG. 5 is a flowchart of a process of the image processing device.

FIG. 6 is a flowchart of the image correction process.

FIG. 7 is an illustration for describing generation of a corrected image.

FIG. 8 illustrates captured images (before correction) and corrected images.

FIG. 9A is a captured image of a situation where snow is falling FIG. 9B is a corrected image in which falling snow is erased.

FIG. 10 illustrates a vehicle on which an image display system is mounted.

### DESCRIPTION OF EMBODIMENTS

Exemplary embodiments will be specifically described with reference to the drawings as necessary. Unnecessarily detailed description may be omitted. For example, well-known techniques may not be described in detail, and substantially identical configurations may not be repeatedly described. This is for the purpose of avoiding unnecessarily redundant description to ease the understanding of those skilled in the art.

Inventors of the present disclosure provide the attached drawings and the following description to enable those skilled in the art to fully understand the disclosure and do not intend to limit the claimed subject matter based on the drawings and the description.

### Exemplary Embodiment

### 1. Configuration

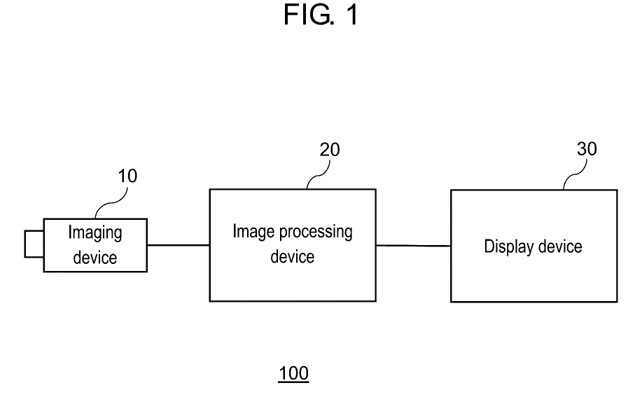

FIG. 1 illustrates a configuration of an image display system according to the present disclosure. As illustrated in FIG. 1, image display system 100 includes imaging device 10, image processing device 20, and display device 30.

Imaging device 10 includes an optical system that forms an object image, an image sensor that converts optical information of an object to an electrical signal in a predetermined imaging period, and an AD convertor that converts an analog signal generated by the image sensor to a digital signal. More specifically, imaging device 10 generates a video signal (digital signal) from optical information of an object input through the optical system and outputs the video signal. Imaging device 10 outputs the video signal (moving image data) in units of frames in a predetermined imaging period. Imaging device 10 is, for example, a digital video camera. The image sensor is constituted by a CCD or a CMOS image sensor, for example.

Image processing device 20 includes an electronic circuit that performs an image correction process on the video signal received from imaging device 10. The whole or a part of image processing device 20 may be constituted by one or more integrated circuits (e.g., LSI or VLSI) designed to perform an image correction process. Image processing device 20 may include a CPU or an MPU and a RAM to perform an image correction process by execution of a predetermined program by the CPU or other units. The image correction process will be specifically described later.

Display device 30 is a device that displays a video signal from image processing device 20. Display device 30 includes a display element such as a liquid crystal display (LCD) panel or an organic EL display panel, and a circuit that drives the display element.

1.1 Image Processing Device

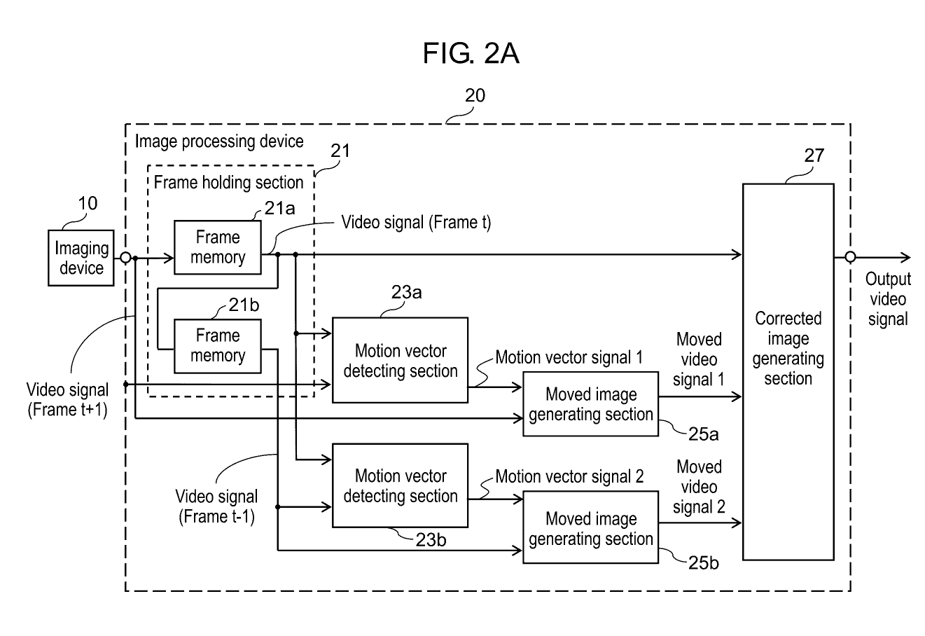

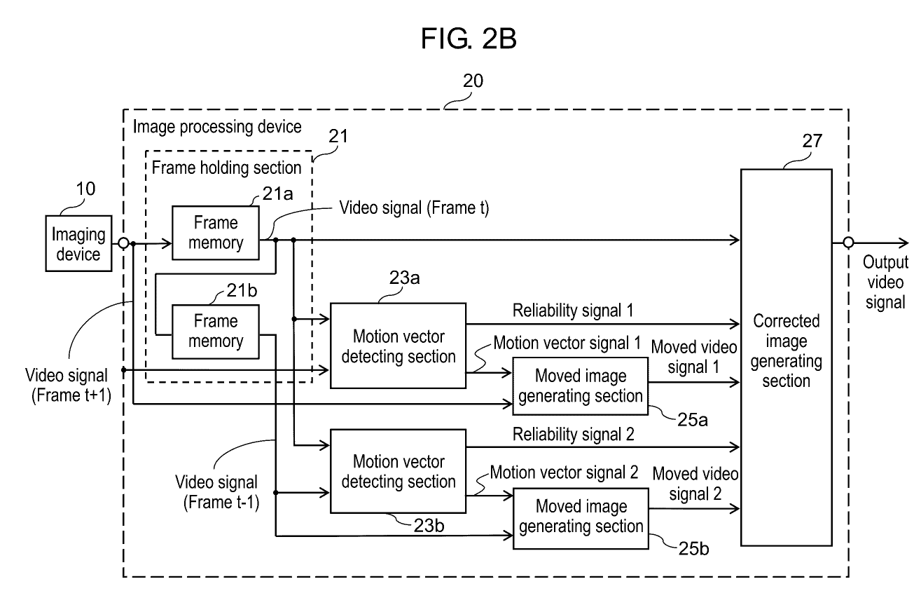

FIG. 2A illustrates a configuration of image processing device 20. Image processing device 20 includes frame holding section 21, motion vector detecting sections 23a and 23b, moved image generating sections 25a and 25b, and corrected image generating section 27. Frame holding section 21 includes frame memory 21a and frame memory 21b.

Image processing device 20 receives a video signal in units of frames from imaging device 10. The video signal received by image processing device 20 is first sequentially stored in frame memories 21a and 21b of frame holding section 21. Frame memory 21a stores a video signal captured before the received video signal by one frame. Frame memory 21b stores a video signal captured before the video signal stored in frame memory 21a by one frame. That is, at the time when a video signal of an n-th frame is input to image processing device 20, frame memory 21a stores a video signal of an n−1-th frame, and frame memory 21b stores a video signal of an n−2-th frame. In the following description, t−1, t, and t+1-th frames will be hereinafter referred to as a “frame t−1,” “frame t,” and “frame t+1,” respectively.

Motion vector detecting section 23a detects a motion vector indicating a motion from a frame indicated by the input video signal to a frame before the frame indicated by the input video signal by one frame, and outputs motion vector signal 1 showing the detection result. Motion vector detecting section 23b detects a motion vector indicating a motion from a frame before the frame indicated by the input video signal by two frames to the frame before the frame indicated by the input video signal by one frame, and outputs motion vector signal 2 showing the detection result. A motion vector is detected in each divided block region of a predetermined size (e.g., 16×16 pixels) in the entire region of an image.

As illustrated in FIG. 2A, motion vector detecting section 23a receives a video signal of frame t from frame memory 21a and receives a video signal of frame t+1 from imaging device 10. Motion vector detecting section 23a detects motion vector 1 indicating a motion from frame t+1 to frame t, and outputs motion vector signal 1 showing the detection result. Motion vector detecting section 23b receives a video signal of frame t−1 from frame memory 21b, and receives a video signal of frame t from frame memory 21a. Motion vector detecting section 23b detects motion vector 2 indicating a motion from frame t−1 to frame t, and outputs motion vector signal 2 showing the detection result.

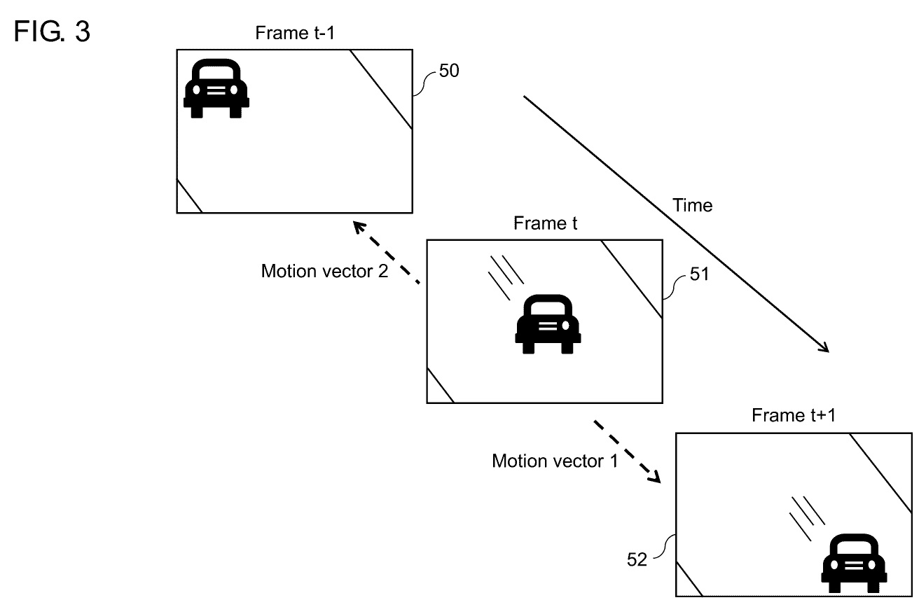

FIG. 3 is an illustration for describing motion vectors 1 and 2 detected by motion vector detecting sections 23a and 23b of image processing device 20. For example, as illustrated in FIG. 3, image processing device 20 receives, from imaging device 10, captured images 50, 51, and 52 in the time order of frame t−1, frame t, and frame t+1. FIG. 3 illustrates a case where an image in which a right headlight of a vehicle is extinguished is captured because of a difference between a driving period of the headlight and an imaging period of imaging device 10 in captured image 51 of frame t. When image processing device 20 receives a video signal of frame t+1, motion vector detecting section 23a detects a motion vector indicating a motion from frame t+1 to frame t, and outputs motion vector signal 1 showing the detection result. Motion vector detecting section 23b detects a motion vector indicating a motion from frame t−1 to frame t, and outputs motion vector signal 2 showing the detection result.

A motion vector may be detected by a known method. For example, an original block region of a predetermined size (e.g., 16×16 pixels) is defined in one frame image, and in another frame image, a region of an image similar to the original block region is defined as a destination block region to which the image is moved. Specifically, a sum of differences in pixel value between two frame images is obtained, and a block region where the sum of differences in pixel value is at the minimum in the other frame image is obtained as the destination block region. Based on the destination block region, a motion direction (vector) of an image region indicated by the original block region can be detected.

As in another configuration of image processing device 20 illustrated in FIG. 2B, motion vector detecting sections 23a and 23b may output reliability signals 1 and 2 indicating reliabilities of motion vector signals 1 and 2, in addition to motion vector signals 1 and 2. For example, in a case where the sum of differences in pixel value between two frames calculated in detecting a motion vector is large, the motion vector is considered to have low reliability. Thus, motion vector detecting sections 23a and 23b output reliability signals 1 and 2 indicating reliabilities of motion vector signals 1 and 2. Reliability signals 1 and 2 are also output for each block region.

As illustrated in FIG. 2A, moved image generating section 25a receives motion vector signal 1 from motion vector detecting section 23a, and receives a video signal of frame t+1 from imaging device 10. Moved image generating section 25b receives motion vector signal 2 from motion vector detecting section 23b, and receives a video signal of frame t−1 from frame memory 21b. When image processing device 20 receives the video signal of frame t+1, moved image generating section 25 generates a first moved image based on the video signal of frame t+1 and motion vector signal 1, and outputs moved video signal 1 showing the generated first moved image. At this time, moved image generating section 25b generates a second moved image based on the video signal of frame t−1 and motion vector signal 2, and outputs moved video signal 2 showing the generated second moved image.

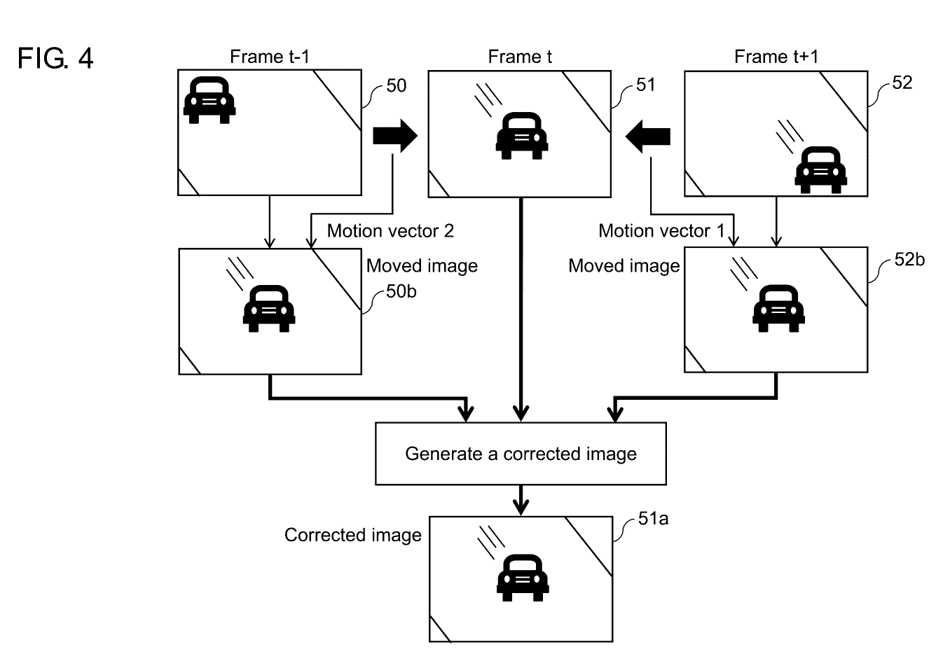

FIG. 4 is an illustration for describing a concept of an image correction process that is performed by image processing device 20. FIG. 4 illustrates a case where image processing device 20 receives, from imaging device 10, captured image 50 of frame t−1, captured image 51 of frame t, and captured image 52 of frame t+1 in this order, as illustrated in FIG. 3. As illustrated in FIG. 4, moved image generating section 25a moves each region (block) of captured image 52 of frame t+1 based on motion vector 1 and, thereby, generates moved image 52b that is a first moved image. That is, moved image 52b is an image generated from captured image 52 based on a motion from captured image 52 of frame t+1 to captured image 51 of frame t. Moved image 52b can be an image in frame t generated based on captured image 52 of frame t+1.

As illustrated in FIG. 4, moved image generating section 25b moves each region (block) of captured image 50 of frame t−1 based on motion vector 2 and, thereby, generates moved image 50b that is a second moved image. That is, moved image 50b is an image generated from captured image 50 based on a motion from captured image 50 of frame t−1 to captured image 51 of frame t. Moved image 50b is an image in frame t generated based on captured image 50 of frame t−1.

Referring back to FIG. 2A, corrected image generating section 27 corrects a specific frame by using images of frames before and after the specific frame, and outputs an output video signal showing the corrected image. Specifically, corrected image generating section 27 corrects frame t based on frame t−1 and of frame t+1 respectively before and after frame t, and outputs an output video signal showing the corrected image of frame t. More specifically, as illustrated in FIG. 2A, corrected image generating section 27 receives the video signal of frame t and moved image signals 1 and 2. Then, as illustrated in FIG. 4, corrected image generating section 27 generates corrected image 51a from captured image 51 of frame t based on moved image 50b of moved image signal 1 and moved image 52b of moved image signal 2, and outputs an output video signal showing the corrected image. A process of corrected image generating section 27 will be specifically described later.

### 2. Operation

An operation of image display system 100 configured as described above will be described. Imaging device 10 captures an image (moving image) of an object in a predetermined imaging period, generates and outputs a video signal. Image processing device 20 performs a correction process (image processing) based on the video signal received from imaging device 10. Display device 30 displays the video signal received from image processing device 20. In particular, in image display system 100 according to this exemplary embodiment, image processing device 20 performs a correction process on a frame to be corrected (hereinafter referred to as a “target frame”), by using images of frames before and after the target frame.

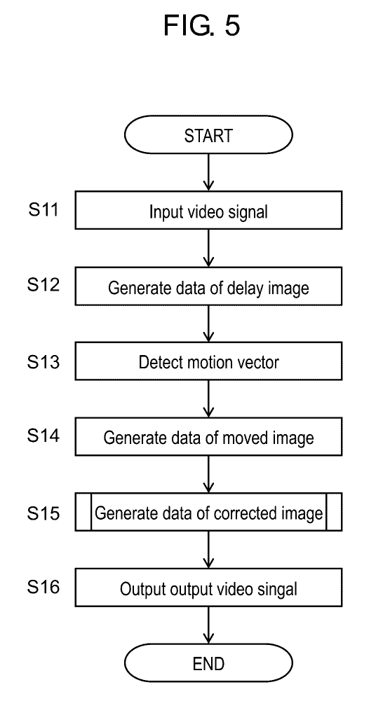

A process in image processing device 20 will now be described with reference to the flowchart of FIG. 5. As illustrated in FIGS. 3 and 4, in the operation that will be described below, frame t is used as a target frame in a state where a video signal showing captured image 52 of frame t+1 is input.

Image processing device 20 receives video signals (frames t−1, t, and t+1) from imaging device 10 (step S11). The received video signals are sequentially stored in frame memories 21a and 21b in units of frames. Specifically, frame memory 21a stores video signal (frame t) corresponding to captured image 51 preceding the received video signal of captured image 52 (frame t+1) by one frame, and frame memory 21b stores video signal (frame t−1) corresponding to captured image 50 preceding the received video signal (frame t+1) of captured image 50 by two frames. In this manner, data of a delay image is generated (step S12).

Next, motion vector detecting sections 23a and 23b detect motion vectors 1 and 2 of captured image 51 of frame t with respect to captured images 50 and 52 of frames t−1 and t+1 before and after captured image 51 of target frame t (step S13).

Specifically, as illustrated in FIG. 3, motion vector detecting section 23a detects motion vector 1 indicating a motion from captured image 52 of frame t+1 to captured image 51 of frame t, and outputs motion vector signal 1 showing the detection result. Motion vector detecting section 23b detects motion vector 2 indicating a motion from captured image 50 of frame t−1 to captured image 51 of frame t, and outputs motion vector signal 2 showing the detection result.

At this time, as in another configuration of image processing device 20 illustrated in FIG. 2B, motion vector detecting sections 23a and 23b can output reliability signals 1 and 2 showing reliabilities of motion vector signals in addition to motion vector signals 1 and 2.

Thereafter, moved image generating sections 25a and 25b generate, from image data of frame t+1 and frame t−1, data of moved images 50b and 52b based on motion vectors 1 and 2 thereof (step S14).

Specifically, moved image generating section 25a generates data of moved image 52b based on data of captured image 52 of frame t+1 and motion vector signal 1, and outputs moved video signal 1 including the generated data of moved image 52b. Moved image generating section 25b generates data of moved image 50b based on data of captured image 50 of frame t−1 and motion vector signal 2, and outputs moved video signal 2 including the generated data of moved image 50b (see FIGS. 2A through 4).

Subsequently, corrected image generating section 27 generates data of corrected image 51a for captured image 51 of frame t by using data of captured image 51 of frame t, which is a correction target, and data of moved images 50b and 52b (step S15), and outputs an output video signal including the generated data of corrected image 51a to display device 30 (step S16).

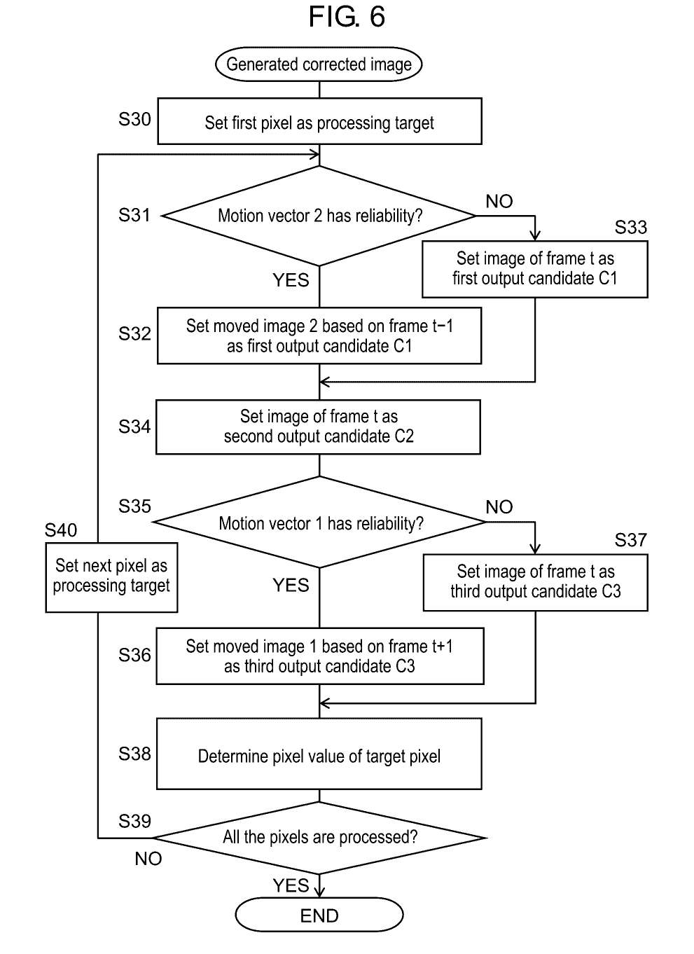

FIG. 6 is a flowchart showing a detail of the generation step (step S15) of corrected image 51a. FIG. 6 is a flowchart in a case where image processing device 20 has a configuration in which reliability signals 1 and 2 are input from motion vector detecting sections 23a and 23b to corrected image generating section 27 as illustrated in FIG. 2B.

Corrected image generating section 27 first sets a first pixel (left top pixel in an image region) as a pixel to be processed (step S30). A series of processes (steps S31 to S38) is performed on each pixel. In this exemplary embodiment, a pixel to be processed is set from the left top pixel toward the right bottom pixel, that is, from left to right and from top to bottom, in an image region.

Corrected image generating section 27 determines, based on reliability signal 2, whether motion vector 2 of the pixel to be processed (i.e., motion vector signal 2 concerning a block region including the pixel to be processed) has reliability or not for captured image 50 of frame t−1 (step S31). In the determination on reliability, if a value indicated by reliability signal 2 is a predetermined value or more, it is determined that motion vector 2 has reliability. If motion vector 2 has reliability (YES in step S31), moved image 50b based on frame t−1 is set as first output candidate C1 with respect to the pixel to be processed (step S32).

If motion vector 2 does not have reliability (NO in step S31), captured image 51 of frame t is set as first output candidate C1 (step S33). Since moved image 50b generated based on motion vector 2 not having reliability is determined to have no reliability (noneffective), captured image 51 of frame t is used as first output candidate C1 in this case.

In a case where corrected image generating section 27 does not receive reliability signal 2 as in image processing device 20 illustrated in FIG. 2A, the process proceeds to step S32 unconditionally without determination in step S31, and moved image 50b based on frame t−1 is set as first output candidate C1.

Subsequently, with respect to the pixel to be processed, captured image 51 of frame t is set as second output candidate C2 (step S34).

Thereafter, with respect to captured image 52 of frame t+1, corrected image generating section 27 determines whether motion vector 1 of the pixel to be processed (i.e., motion vector signal 1 concerning a block region including the pixel to be processed) has reliability or not, based on reliability signal 1 (step S35). In the determination on reliability, if a value indicated by reliability signal 1 is a predetermined value or more, it is determined that motion vector 1 has reliability. If motion vector 1 has reliability (YES in step S35), moved image 52b based on frame t+1 is set as third output candidate C3 with respect to the pixel to be processed (step S36).

On the other hand, if motion vector 1 does not have reliability (NO in step S35), captured image 51 of frame t is set as third output candidate C3 (step S37). Since moved image 52b generated based on a motion vector not having reliability is determined to have no reliability (noneffective), captured image 51 of frame t is used as third output candidate C3 in this case.

In a case where corrected image generating section 27 does not receive reliability signal 1 as in image processing device 20 illustrated in FIG. 2A, the process proceeds to step S36 unconditionally without determination in step S35, and moved image 52b based on frame t+1 is set as third output candidate C3.

As described above, basically, moved image 50b based on frame t−1 is used as first output candidate C1, and moved image 52b based on frame t+1 is used as third output candidate C3. In a case where moved image 50b or 52b does not have reliability, however, captured image 51 of frame t is used as first output candidate C1 or third output candidate C3.

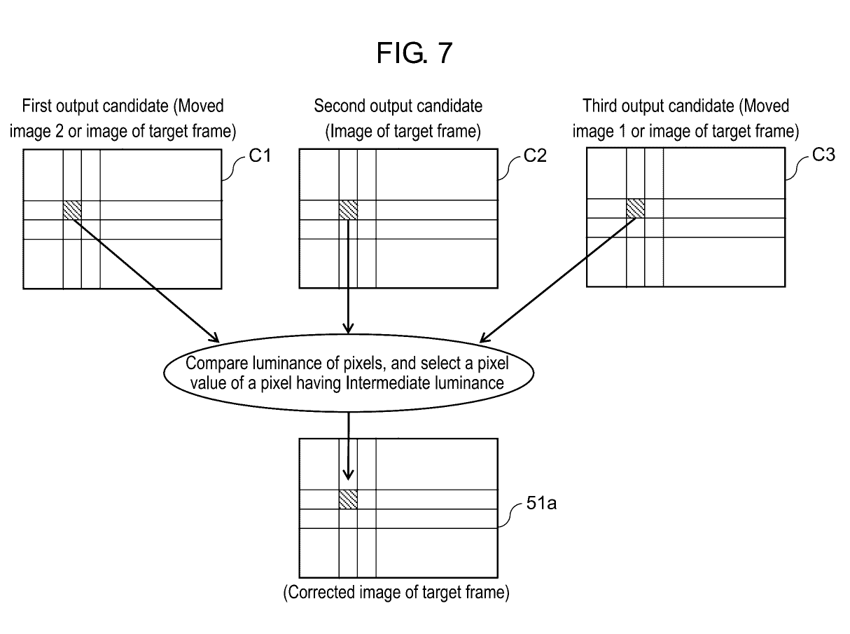

Subsequently, corrected image generating section 27 determines a pixel value of the pixel to be processed in corrected image 51a with reference to image data of first to third output candidates C1 to C3 (i.e., captured image 51 of frame t and moved images 50b and 52b) (step S38). Specifically, as illustrated in FIG. 7, corrected image generating section 27 compares luminance values in units of pixels among three images of first to third output candidates C1 to C3, and employs a pixel value of a pixel having the second highest (or lowest) luminance as a pixel value of the pixel in corrected image 51a. In this manner, a pixel value of each pixel in the corrected image is determined. In sum, Table 1 shows relationships between luminance values of pixels in first to third output candidates C1 to C3 and output candidates C1 to C3 employed as pixel values.

TABLE 1

| Relationship in pixel luminance value | Output candidates employing pixel |
|---|---|
| among output candidates | values |
| C2 luminance ≦ C1 luminance ≦ C3 | first output candidate C1 |
| luminance ≦ or | (i.e., replaced by pixel of image of |
| C3 luminance ≦ C1 luminance ≦ C2 | frame t − 1) |
| luminance ≦ | |
| C1 luminance ≦ C2 luminance ≦ C3 | second output candidate C2 |
| luminance ≦ or | (i.e., use pixel of image of frame t |
| C3 luminance ≦ C2 luminance ≦ C1 | without change) |
| luminance ≦ | |
| C1 luminance ≦ C3 luminance ≦ C2 | third output candidate C3 |
| luminance ≦ or | (i.e., replaced by pixel of image of |
| C2 luminance ≦ C3 luminance ≦ C1 | frame t + 1) |
| luminance ≦ | |

The processes described above are performed on all the pixels (steps S39 and S40) so that corrected image 51a is generated.

As described above, in this exemplary embodiment, with respect to captured image 51 of target frame t, corrected image 51a is generated from captured image 51 of frame t (second output candidate) and moved images 50b and 52b (first and third output candidates C1 and C3) generated from frames t−1 and t+1 before and after the frame t in consideration of a motion vector. In this manner, in three consecutive frames, in the case of capturing an image in which a luminance of a pixel in target frame t is significantly different from luminances of corresponding pixels in frames t−1 and t+1 before and after frame t in consecutive three frames, correction can be performed by replacing a pixel value of the pixel of target frame t by pixel values of frames before and after frame t.

Here, in this exemplary embodiment, as shown in step S38 in FIG. 6 and Table 1, a pixel value of a pixel having an intermediate (between minimum and maximum) luminance value in three images of first to third output candidates C1 to C3 is employed as a pixel value of corrected image 51a. In the case of employing the pixel value of the pixel having the intermediate (between minimum to maximum) luminance value as a pixel value of corrected image 51a as described above, even if original captured image 51 is correct and the image processing described here performs erroneous correction, there is an advantages of reducing the influence of the erroneous correction on the image. If such an influence is negligible, a pixel value of a pixel having the maximum luminance value in three images of first to third output candidates C1 to C3 may be employed as a pixel value of corrected image 51a.

With the foregoing configuration, in a case where a pixel in frame t has a low luminance and corresponding pixels in frames t−1 and t+1 before and after frame t have high luminances, the luminance of the pixel in frame t is corrected to a high luminance. In contrast, in a case where the pixel in frame t has a high luminance and corresponding pixels in frames t−1 and t+1 before and after frame t have low luminances, the luminance of the pixel in frame t is corrected to a low luminance. In this manner, a variation in luminance among frames can be made smooth.

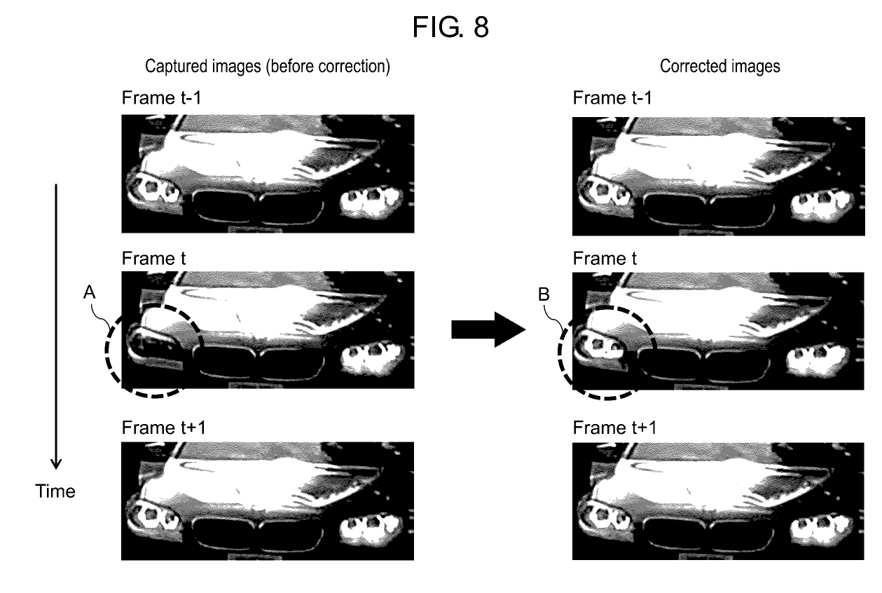

For example, in the case of capturing a headlight including an LED device, an image showing a state where the headlight is extinguished (in portion A of FIG. 8) only in some frames (frame t) is captured in some cases as illustrated in captured images (before correction) in FIG. 8, because of a difference between a driving period of the LED device and an imaging period of the imaging device. In such a case, image display system 100 according to this exemplary embodiment can correct captured image 51 of frame t to an image showing a state in which the headlight is lightened (in portion B in FIG. 8) based on captured images 50 and 52 of frames t−1 and t+1 before and after frame t, as illustrated in corrected images in FIG. 8. In this manner, the headlight is lit in all the images of consecutive three frames t−1, t, and t+1, and flicker can be reduced.

In the exemplary embodiment described above, the correction process is performed by using three frames t−1, t, and t+1. The number of frames, however, for use in the correction process is not limited to three. For example, the correction process may be performed by using two frames before target frame t and two frames after target frame t. That is, the correction process may be performed by using five frames t−2, t−1, t, t+1, and t+2, or a larger number of frames may be used.

Frames that are used together with a target frame in the correction process do not need to be frames continuous to the target frame, that is, frames t−1 and t+1 immediately before and immediately after target frame t.

For example, the correction process may be performed by using frame t−2 preceding target frame t by two frames, and frame t+2 subsequent to target frame t by two frames. That is, in the correction process, it is sufficient to use at least one frame before the target frame and at least one frame after the target frame. In some driving periods of, for example, a light-emitting device as a target to be captured, advantages of the correction process can be more significantly obtained by using frames farther from the target frame in terms of time (e.g., frames t−2 and t+2), rather than frames immediately before and immediately after the target frame in some cases. It should be noted that reliabilities of motion vectors 1 and 2 detected by motion vector detecting sections 23a and 23b tend to be higher in the case of using frames immediately before and immediately after the target frame than those in the case of not using such frames. As the frames before and after the target frame for use in the correction process become farther from the target frame in terms of time, the number of frames that need to be held by frame holding section 21 illustrated in FIG. 2A increases. Thus, a load of a circuit in image processing device 20 tends to be smaller in the case of using frames immediately before and immediately after the target frame.

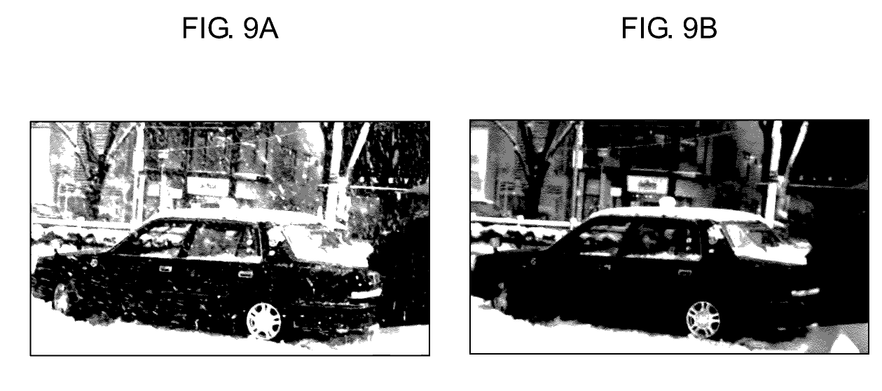

The use of the process by image processing device 20 according to this exemplary embodiment can generate a corrected image in which falling snow is erased as illustrated in FIG. 9B, from an image showing a situation where snow is falling as illustrated in FIG. 9A. That is, an object that reduces visual recognizability, such as snow, can be erased in a captured image. In this case, a block region where a motion vector is detected is set in a size sufficiently large relative to snow particles so as not to detect a motion vector of particles of falling snow. In addition, in this case, in step S38 of the flowchart in FIG. 6 and Table 1, a pixel value of a pixel having the minimum luminance value among the first to third output candidates C1 to C3 may be employed as a pixel value of a corrected image, instead of the pixel value of a pixel having an intermediate (second) luminance value.

### 3. Advantages and Others

Image processing device 20 according to this exemplary embodiment includes motion vector detecting section 23a, motion vector detecting section 23b, moved image generating section 25a, moved image generating section 25b, and corrected image generating section 27. Motion vector detecting section 23a detects motion vector 1 indicating a motion from captured image 52 of frame t+1 that is a frame subsequent frame t to captured image 51 of frame t. Motion vector detecting section 23b detects motion vector 2 indicating a motion from captured image 50 of frame t−1 that is a frame preceding frame t to captured image 51 of frame t. Moved image generating section 25a generates data of moved image 52b based on data of captured image 52 of frame t+1 and motion vector 1. Moved image generating section 25b generates data of moved image 50b based on data of captured image 50 of frame t−1 and motion vector 2. Corrected image generating section 27 generates data of corrected image 51a obtained by correcting captured image 51 of frame t, based on data of captured image 51 of frame t, data of moved image 52b, and data of moved image 50b.

Image display system 100 according to this exemplary embodiment includes imaging device 10 that captures an image in units of frames and generates image data, image processing device 20 that receives the image data from imaging device 10, and display device 30 that displays an image indicated by data of corrected image 51a generated by image processing device 20.

An image processing method disclosed in this exemplary embodiment includes the steps of detecting motion vector 1, detecting motion vector 2, generating data of moved image 52b, generating data of moved image 50b, and generating and outputting data of corrected image 51a. Motion vector 1 indicates a motion from captured image 52 of frame t+1 that is a frame subsequent to frame t to captured image 51 of frame t. Motion vector 2 indicates a motion from captured image 50 of frame t−1 that is a frame preceding frame t to captured image 51 of frame t. The data of moved image 52b is generated based on data of captured image 52 of frame t+1 and motion vector 1. The data of moved image 50b is generated based on data of captured image 50 of frame t−1 and motion vector 2. The data of corrected image 51a is generated by correcting captured image 51 of frame t, based on data of captured image 51 of frame t, data of moved image 52b, and data of moved image 50b.

The image processing method disclosed in this exemplary embodiment can be a program that causes a computer to execute the steps described above.

In image processing device 20 and the image processing method according to this exemplary embodiment, image data of a target frame is corrected by using image data of frames before and after the target frame so that a pixel having a different luminance only in one frame among corresponding pixels in the frames can be corrected. In this manner, for example, it is possible to generate a video image with reduced flicker that can occur because of a difference between a driving period of a light-emitting device (LED device) that is an object and an imaging period of imaging device 10. In addition, it is also possible to generate a video image in which an object that reduces visual recognizability, such as snow, is erased.

Imaging device 10, image processing device 20, and display device 30 described in the above exemplary embodiment are examples of an imaging device, an image processing device, and display device, respectively, according to the present disclosure. Frame holding section 21 is an example of a frame holding section. Motion vector detecting sections 23a and 23b are examples of motion vector detecting sections. Moved image generating sections 25a and 25b are examples of moved image generating sections. Corrected image generating section 27 is an example of a corrected image generating section. Frame t is an example of a target frame, frame t−1 is an example of a preceding frame, and frame t+1 is an example of a subsequent frame.

### Other Exemplary Embodiments

In the above description, the exemplary embodiment has been described as an example of a technique disclosed in this application. The technique disclosed here, however, is not limited to this embodiment, and is applicable to other embodiments obtained by changes, replacements, additions, and/or omissions as necessary. Other exemplary embodiments will now be described.

Image processing by image processing device 20 according to the exemplary embodiment described above is effective for images of not only an LED headlight but also a traffic light constituted by an LED device. That is, the image processing is effective for the case of capturing a device including a light emitting device driven in a period different from an imaging period of imaging device 10.

In the exemplary embodiment described above, the size of the block region where a motion vector is detected is fixed, but may be variable depending on the size of an object to be corrected (e.g., an LED or a traffic light). In a case where the size difference between the object to be corrected and the block region is small, a motion vector cannot be correctly detected for a block region including the object in some cases. Thus, to accurately detect a motion vector in the block region including the object to be corrected, the size of the block region may be sufficiently large for the object. For example, the size of the block region may be increased depending on the size of a region of a headlight of a vehicle detected from a captured image.

In the above exemplary embodiment, the image processing by image processing device 20 is applied to the entire captured image, but may be applied only in a region of the captured image. For example, the imaging processing may be performed only on a region of a predetermined object (e.g., vehicle, headlight, or traffic light) in an image. In this manner, it is possible to reduce erroneous correction of a region that does not need to be corrected originally.

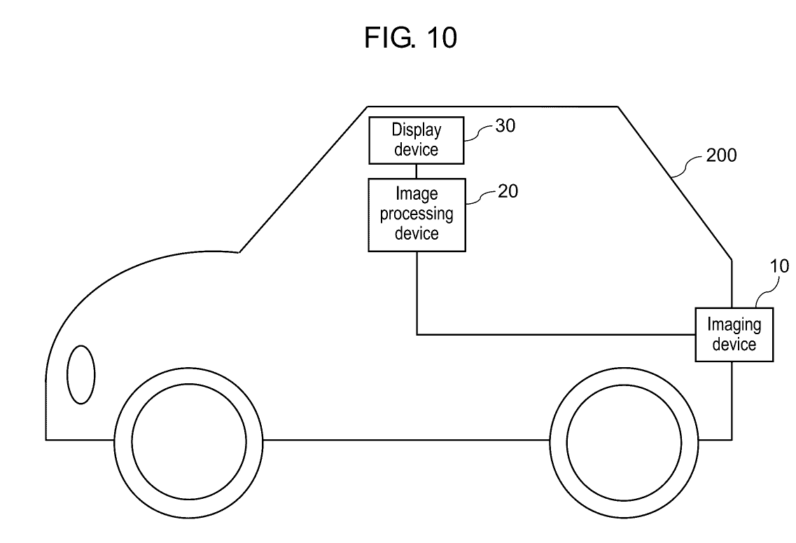

Image display system 100 according the exemplary embodiment may be mounted on a vehicle, for example. FIG. 10 is a configuration of vehicle 200 on which image display system 100 is mounted. In this case, imaging device 10 is disposed in a rear portion of vehicle 200 and captures a situation at the rear of the vehicle. Display device 30 and image processing device 20 may be embedded in a room mirror. In this case, the room mirror may be configured such that when display device 30 is turned on, an image captured by imaging device 10 is displayed on display device 30 and, when display device 30 is turned off, a situation at the rear of vehicle 200 can be seen with the mirror. A driver of vehicle 200 can recognize the situation at the rear of the vehicle by seeing an image on display device 30.

Image processing device 20 according to the exemplary embodiment described above is also applicable to a drive recorder mounted on a vehicle. In this case, a video signal output from image processing device 20 is recorded on a recording medium (e.g., a hard disk or a semiconductor memory device) of a drive recorder.

In the foregoing description, exemplary embodiments have been described as examples of the technique of the present disclosure. For this description, accompanying drawings and detailed description are provided.

Thus, components provided in the accompanying drawings and the detailed description can include components unnecessary for solving problems as well as components necessary for solving problems. Therefore, it should not be concluded that such unnecessary components are necessary only because these unnecessary components are included in the accompanying drawings or the detailed description.

Since the foregoing exemplary embodiments are examples of the technique of the present disclosure, various changes, replacements, additions, and/or omissions may be made within the range recited in the claims or its equivalent range.

### INDUSTRIAL APPLICABILITY

The present disclosure is applicable to a device that can capture an image by an imaging device and causes the captured image to be displayed on a display device or recorded on a recording medium, such as a room mirror display device or a driver recorder, mounted on a vehicle, for example.

What is claimed is:

1. An image processing device comprising:
a first motion vector detecting section that detects a first motion vector indicating a motion from a subsequent frame subsequent to a target frame to the target frame;
a second motion vector detecting section that detects a second motion vector indicating a motion from a previous frame preceding the target frame to the target frame;
a first moved image generating section that generates data of a first moved image based on data of the subsequent frame and the first motion vector;
a second moved image generating section that generates data of a second moved image based on data of the previous frame and the second motion vector; and
a corrected image generating section that generates data of a corrected image in which the target frame is corrected, based on data of the target frame, the data of the first moved image, and the data of the second moved image.

2. The image processing device of claim 1, wherein
the subsequent frame is a frame immediately after the target frame, and
the previous frame is a frame immediately before the target frame.

3. The image processing device of claim 1, wherein
the corrected image generating section sets a pixel value of a pixel showing a second highest luminance value among corresponding pixels in the data of the target frame, the data of the first moved image, and the data of the second moved image, as a pixel value of a corresponding pixel in the data of the corrected image.

4. The image processing device of claim 1, wherein
the first motion vector detecting section outputs a first reliability signal showing reliability of the first motion vector,
the second motion vector detecting section outputs a second reliability signal showing reliability of the second motion vector, and
in generating the data of the corrected image, the corrected image generating section
uses the data of the first moved image if the first reliability signal shows presence of the reliability of the first motion vector, and
uses the data of the second moved image if the second reliability signal shows presence of the reliability of the second motion vector.

5. An image display system comprising:
an imaging device that captures an image in units of frames and generates image data;
the image processing device of claim 1 that receives the image data from the imaging device; and
a display device that displays an image shown by the data of the corrected image generated by the image processing device.

6. A vehicle comprising
the image display system of claim 5.

7. An image processing method comprising the steps of:
detecting a first motion vector indicating a motion from a subsequent frame subsequent to a target frame to the target frame;
detecting a second motion vector indicating a motion from a previous frame preceding the target frame to the target frame;
generating data of a first moved image based on data of the subsequent frame and the first motion vector;
generating data of a second moved image based on data of the previous frame and the second motion vector; and
generating and outputting data of a corrected image in which the target frame is corrected, based on data of the target frame, the data of the first moved image, and the data of the second moved image.

8. The image processing method of claim 7, wherein
the subsequent frame is a frame immediately after the target frame, and
the previous frame is a frame immediately before the target frame.

9. A recording medium that records a program causing a computer to execute the image processing method of claim 7.
